(19) United States
(12) Patent Application Publication
(10) Pub. No.: US 2025/0178392 A1
(43) Pub. Date: Jun. 5, 2025

(54) REAR COVER FOR A REAR-SIDE RECEPTACLE, FIXED TO THE VEHICLE, FOR A TOWING DEVICE OF A MOTOR VEHICLE, AND MOTOR VEHICLE WITH A REAR AREA AND A RECEPTACLE OF THAT TYPE

(71) Applicant: BOS GmbH & Co. KG, Ostfildern (DE)

(72) Inventors: Mickey HANNAN, Shelby Township, MI (US); David RACE, Commerce Township, MI (US); Satya Akhil Reddy BACHUGUDAM, Rochester Hills, MI (US); Siddhartha BABBURI, Novi, MI (US)

(21) Appl. No.: 18/958,342

(22) Filed: Nov. 25, 2024

Related U.S. Application Data
(60) Provisional application No. 63/604,345, filed on Nov. 30, 2023.

(51) Int. Cl. B60D 1/60

(52) U.S. Cl. CPC B60D 1/60

(57) ABSTRACT

A rear cover for a rear-side receptacle, fixed to the vehicle, for a towing device of a motor vehicle, and a motor vehicle. The rear cover has a cover element movably mounted on the vehicle side and a control mechanism arranged on the vehicle side and carrying the cover element. The control mechanism moves the cover element between an open position exposing the receptacle, and a closed position covering the receptacle.

### CROSS-REFERENCE TO RELATED APPLICATION

This claims priority from U.S. Provisional Application No. 63/604,345, filed Nov. 30, 2023, the disclosure of which is hereby incorporated by reference in its entirety.

### TECHNICAL FIELD

The invention relates to a rear cover for a rear-side receptacle, fixed to the vehicle, for a towing device of a motor vehicle. The invention additionally relates to a motor vehicle with a rear area which has a receptacle, fixed to the vehicle, for fitting a towing device.

### BACKGROUND AND SUMMARY

Motor vehicles with towing devices are generally known. In the USA in particular, corresponding towing devices are fixable in a receptacle, fixed to the vehicle, in a rear area of a motor vehicle. The receptacle is designed as a rectangular tube open to the rear, which is positioned centrally in a rear area of the motor vehicle and is permanently connected to carrier structure parts of the motor vehicle. A hitch ball of the towing device is fastened to an also rectangular-shaped section, which is slidable into the rectangular tube of the receptacle on the vehicle side and securable in the slid-in position by means of a pin. To protect the open face of the rectangular tube of the receptacle when the hitch ball is not fitted, a cover is fittable onto the open face of the rectangular tube.

The object of the invention is to provide a rear cover and a motor vehicle of the type stated at the outset, permitting improved protection of the receptacle when a hitch ball is not fitted and simple accessibility of the receptacle for fitting of a hitch ball.

The rear cover in accordance with the invention has a movably mounted cover element on the vehicle side. In addition a control mechanism, which is arranged on the vehicle side and carries the cover element, is provided to move the cover element between an open position exposing the receptacle and a closed position covering the receptacle. Since the cover element remains permanently on the motor vehicle, this cover element cannot be lost. Due to the movability of the cover element between the closed position covering the receptacle and the open position exposing it, an operator may move the cover element as required in order to fit or remove a hitch ball of the towing device at the receptacle on the vehicle side. The operator can manually move the cover element into the open position or into the closed position. As a general principle, it is also possible to assign to the control mechanism a drive unit by means of which an automatic and forced movement of the cover element into the closed position and/or into the open position is enabled. The solution according to the invention is suitable for both passenger cars and for trucks or commercial vehicles.

In one development of the invention, the cover element is designed such that in its closed position it is integrated flush into the rear contour of the motor vehicle. The result of this is firstly a visually attractive contour of the entire rear area of the motor vehicle in the closed position. Also, the flush integration of the cover element into the rear contour of the motor vehicle ensures an aerodynamically favorable rear area which can reduce a drag coefficient of the motor vehicle. Finally, the flush integration of the cover element into the rear contour permits simple and safe cleaning of the rear area of the motor vehicle when the cover element is in the closed position. The flush integration of the cover element also permits completely dirt-excluding closing of the receptacle on the vehicle side and of the direct surroundings of the receptacle on the vehicle side in the rear area of the motor vehicle.

In a further development of the invention, the cover element is designed as a plastic component. The plastic component may be designed as one or more parts. The cover element is preferably handleable as a one-part component.

In a further development of the invention, the control mechanism is assigned a drive unit which drives a movement of the cover element in at least one direction. The drive unit may be of electrical, hydraulic, pneumatic or mechanical design. Particularly advantageously, the drive unit has at least one spring motor. A torsion spring effective in one direction of rotation is preferably provided as the spring motor. The spring motor is effective in one direction of rotation, so that the control mechanism is assisted or exclusively driven in one direction by a torque of the at least one spring motor. In the opposite direction, the control mechanism must be moved manually by an operator against the torque of the at least one spring motor. A torque of the at least one spring motor is designed so that such a manual counter-movement by an operator is possible without major effort. In a further development of the invention, the drive unit has at least one spring motor.

In a further development of the invention, the drive unit has at least one crank mechanism, which is mechanically coupled to the control mechanism. A corresponding mechanical crank mechanism permits a particularly simple and safe activation of the control mechanism.

In a further development of the invention, a locking device is provided which secures the cover element in the closed position. The locking device may be activatable mechanically, electrically, hydraulically or pneumatically. Particularly advantageously, the locking device is of mechanical design and permits manual unlocking or locking.

In a further development of the invention, the control mechanism has a slot guide assigned to the cover element, wherein the slot guide is designed such that the cover element inevitably performs a combined swiveling and longitudinal movement between the closed position and the open position. A swivel movement component is performed about a swivel axis extending in the vehicle transverse direction. A longitudinal movement component is provided along a vehicle longitudinal axis.

In a further development of the invention, the slot guide is equipped with two slot guide tracks fixed to the vehicle and two sliding blocks forcibly moving in the slot guide tracks, wherein the sliding blocks are fastened to support arms of the cover element. The support arms are integral components of the cover element.

In a further development of the invention, the cover element has identical support arms with sliding blocks fastened thereon on two opposite sides; the cover element is flanked on each of the two sides by one carrier part fixed to the vehicle and having slot guide tracks identical to one another in which the sliding blocks are forcibly moved; and a synchronizing device is provided which effects a synchronous movement of the opposite support arms of the cover element relative to the slot guides. The opposite slot guides, which consist of sliding blocks on the opposite support arms and of slot guide tracks on the opposite carrier parts, form part of the control mechanism. This design results in stable support of the cover element both for its two end positions and for a corresponding repositioning movement. Also, the dual guidance of the cover element on opposite sides permits a particularly stable repositioning movement.

In a further development of the invention, two identical crank mechanisms are assigned to the carrier parts and are coupled to the support arms of the cover element. The drive unit thus has two identical crank mechanisms which enable a synchronized movement of the support arms, four in total, of the cover element on both sides.

In a further development of the invention, the synchronizing device has a coupling section extending transversely between the opposite carrier parts, which is rotatably mounted on the carrier parts and has at opposite front end areas two crank rockers, arranged in co-rotating manner, of the two crank mechanisms. The coupling section ensures synchronous movement of the opposite crank mechanisms.

In a further development of the invention, two spring motors are provided coaxially to a rotation axis of the coupling section, which are each assigned to one crank rocker and exert a rectified torque on the two crank rockers. The two spring motors are designed identical, so that they exert identical torques on the crank rockers and on the coupling section.

Further advantages and features of the invention can be found in the claims and in the following description of a preferred example of the invention that are explained on the basis of the drawing.

### BRIEF DESCRIPTION OF THE DRAWINGS

FIG. 1 shows in a perspective representation an embodiment of a rear cover in accordance with the invention for a rear area of a motor vehicle in an open position of a cover element;

FIG. 2 shows in a perspective representation the rear cover according to FIG. 1, but in a closed position of the cover element;

FIG. 3 the rear cover according to FIG. 1 in a front view;

FIG. 4 the rear cover according to FIG. 2 in a view from below;

FIG. 5 the rear cover according to FIG. 1 in a side view; and

FIG. 6 the rear cover according to FIG. 2, also in a side view.

### DETAILED DESCRIPTION

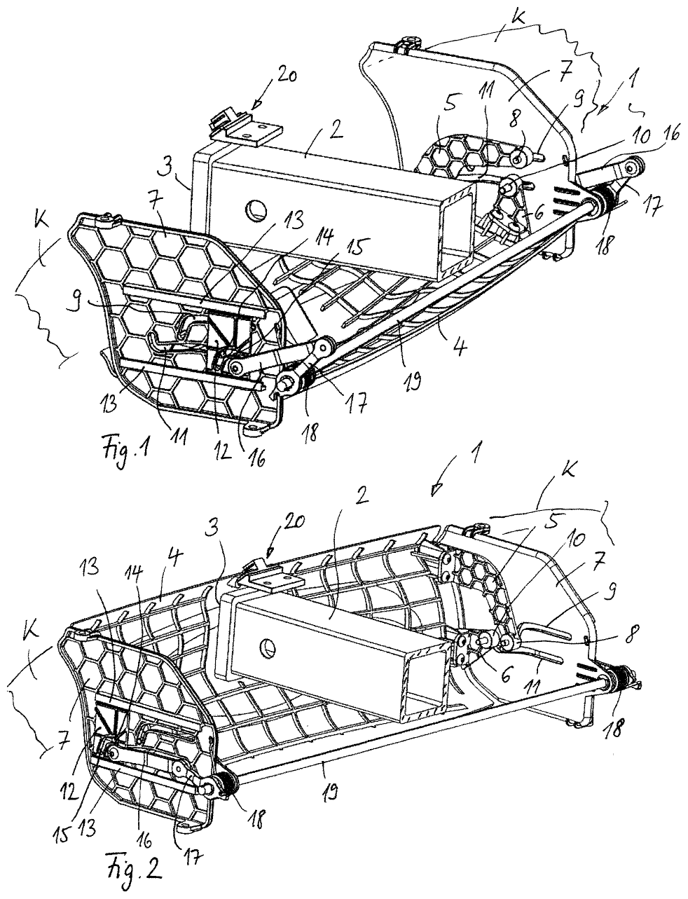

A motor vehicle K, only indicated in FIGS. 1 and 2, has in a rear area along a central longitudinal axis of the motor vehicle a receptacle 2 which is designed as a rectangular hollow section made of steel. The receptacle 2 is permanently connected to carrier structure parts of the motor vehicle K in the rear area of the motor vehicle K, preferably to a chassis or to a bodywork supporting structure of the motor vehicle K. The receptacle 2 is open towards a vehicle rear, forming a receptacle opening 3. A rectangular-shaped carrier section of a hitch ball of a towing device is insertable into the receptacle opening 3 and is lockable in the receptacle 2 by means of a transverse pin. A passage for receiving the transverse pin is discernible in the receptacle 2 in FIGS. 1 and 2.

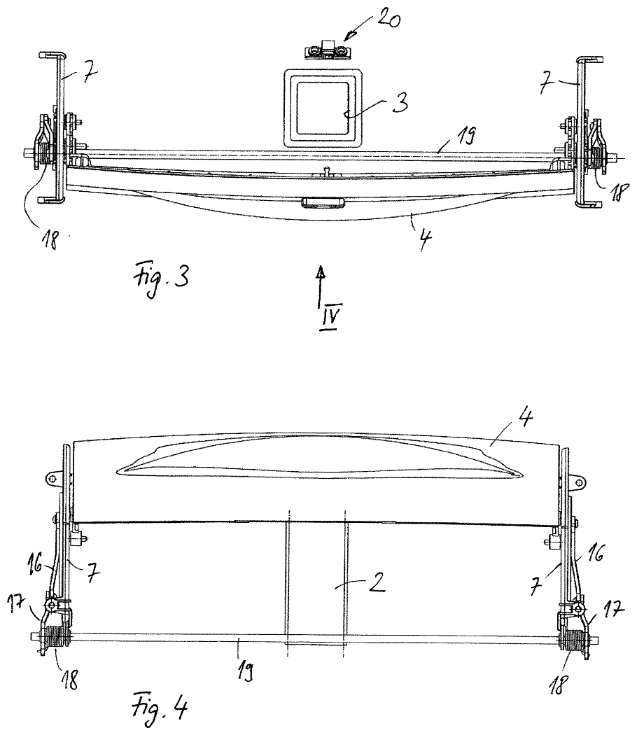

In order to cover the receptacle opening 3 and to close off the surroundings of the rear area of the motor vehicle K around the receptacle 2 when the carrier section carrying the hitch ball is not fitted, a rear cover 1 is provided, as described in more detail in the following based on FIGS. 1 to 6. The rear cover 1 has on the vehicle side-in each case at an equal distance to opposite side flanks of the receptacle 2 in the vehicle transverse direction-two plate-like carrier parts 7 extending in the vehicle vertical direction and in the vehicle longitudinal direction, and fixed to the vehicle in the rear area of the motor vehicle K. The rear cover 1 has a cover element 4 which is designed as a plastic component in the form of a shell-like body. The shell shape of the body is adapted to a rear contour of the rear area of the motor vehicle K, so that the cover element 4 closes, in its closed position (FIGS. 2, 4 and 6), a space remaining between the two carrier parts 7 in the area of the receptacle 2 behind the receptacle opening 3 in a flush manner to the rear contour of the motor vehicle K. The cover element 4 has, on each of its lateral edge areas adjacent to the carrier parts 7, two support arms 5 and 6 which are permanently connected to an inner surface of the cover element 4 and are aligned, starting from the inner surface of the cover element 4, in a plane created by a vehicle longitudinal axis and a vertical axis, and hence parallel to the carrier parts 7. Accordingly, two inward projecting and longer support arms 5, and two shorter support arms 6 at a distance to the support arms 5, are fastened to the cover element 4. The support arms 5 have a curved shape, in the manner of a boomerang, in the plane created from the vehicle longitudinal axis and vehicle vertical axis. The support arms 6 are designed as substantially triangular extensions projecting from the inner surface of the cover element 4.

Sliding blocks 8 and 10 are arranged at free end areas of the support arms 5 and 6 respectively, and are each displaceably mounted in a slot guide track 9, 11 of a slot guide of the carrier part 7. Upper slot guide tracks 9 identical to one another and lower slot guide tracks 11 identical to one another are provided in the opposite carrier parts 7. The slot guide tracks 9 and 11 are designed as slot-like passages in the respective carrier part 7. Each sliding block 8, 10 of the support arms 6, 5 has a journal guided in linearly movable manner in the respective slot guide track 9, 11. Each journal is designed cylindrical. The journals of the sliding blocks 10 of the support arms 5 also have a journal section 14 continued outwards in the vehicle transverse direction and projecting into an arc-shaped slot guide 15 of a plate-like slide 12. Each slide 12 is guided in longitudinally displaceable manner over a surface provided on the outside of the carrier part 7 in the vehicle transverse direction. For that purpose, each carrier part 7 has on the outside two guide rails 13 which guide the slide 12 in linearly movable manner at the upper and lower sides.

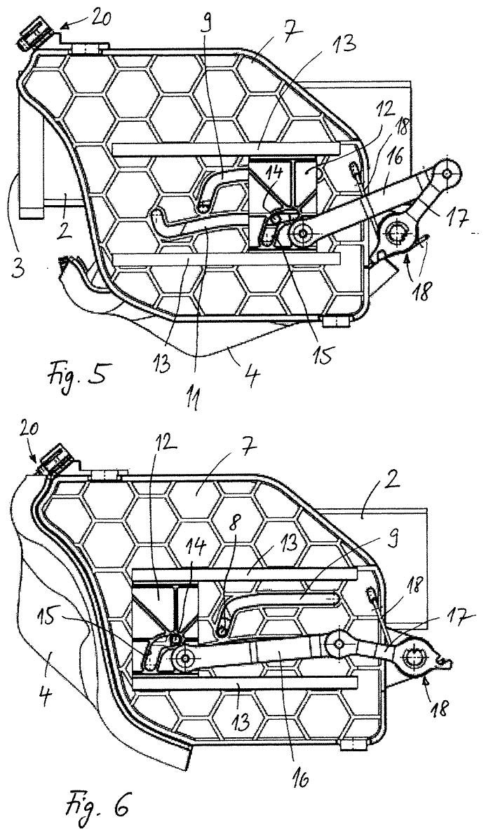

Each slide 12 is displaceable along the guide rails 13 by means of a crank mechanism. The two crank mechanisms are designed identical to one another and are mounted on end areas—at the front when seen in the vehicle longitudinal direction—of the carrier parts 7. A crank rocker 17 is mounted rotatably movable about a rotation axis extending in the vehicle transverse direction. The crank rocker 17 is pivotably connected to the slide 12 by means of a coupling bar 16. A spring motor 18, which exerts a torque on the respective crank rocker 17 in one direction of rotation, is also assigned to each crank rocker 17. In the illustrations according to FIGS. 1 and 2 and to FIGS. 5 and 6, the torque exerted by the spring motors 18 is exerted clockwise. As a result, the slides 12 are inevitably always moved, due to the torque of the spring motor 18, along the guide rails 13 into an end position, shifted forwards in the vehicle longitudinal direction, corresponding to the open position of the cover element 4.

To ensure that the opposite slides 12 are moved evenly, simultaneously and in the same direction, a synchronizing device is assigned to the two crank mechanisms and to the two spring motors 18, and has a bar-like coupling section 19 extending in the vehicle transverse direction coaxially to the rotation axis of the two crank rockers 17. The coupling section 19 is mounted, rotatable relative to the two carrier parts 7, on corresponding mounting extensions at the front end areas of the carrier parts 7. The two crank rockers 17 are held coaxially on this coupling bar 19 in co-rotating manner.

Due to the slot guides described in conjunction with the crank mechanisms and with the synchronizing device, the cover element 4 is movable between an open position (FIGS. 1, 3 and 5) and a closed position (FIGS. 2, 4 and 6). A movement of the slides 12 using the slot guide 15 and the extended sliding block journal section 14 is transferred to the respective sliding block 10 of the support arms 6, whereby a swivel movement of the cover element 4 and a movement of the sliding blocks 8 of the support arms 5 in the respective upper slot guide track 9 inevitably results due to the sliding along of the sliding blocks 10 in the lower slot guide tracks 11 of the carrier parts 7.

To secure the cover element 4 in the closed position despite the permanently acting force of the spring motors 18, a locking device 20 is provided which is positioned centrally on the vehicle side above the receptacle opening 3. The cover element 4 has a counter-element with which a blocking element of the locking device 20 positively interacts when the cover element 4 is moved into its closed position. Preferably, the locking device 20 inevitably engages in its locking position as soon as the cover element 4 is swiveled upwards into the closed position and the counter-element has reached the blocking element of the locking device 20. The locking device 20 may be released manually by an operator who mechanically releases the locking device 20 by means of an actuating member, not shown or described in detail. A spring device which is part of the locking device 20 may inevitably push the blocking element back into the blocking position after release, so that the cover element 4 is inevitably engaged or locked in the blocking position when it is again moved into the closed position.

After release of the locking device 20 in the closed position of the cover element 4, a control mechanism formed by the slot guides in conjunction with the synchronizing device inevitably moves the cover element 4 into its open position due to the spring force of the spring motors 18. If the open rear area, which permits accessibility to the receptacle opening 3 of the receptacle 2, is to be closed again, the cover element 4 is manually moved by an operator rearwards and upwards in simple manner against the spring force of the spring motors 18, until the cover element is again positively interacting with the blocking element of the locking device 20 in the area of its upper edge by means of its counter-element. This secures the cover element 4 in the closed position again.

1. A rear cover for a rear-side receptacle fixed to a motor vehicle, for use with a towing device of the motor vehicle, with the rear cover comprising a cover element movably mounted on a vehicle side, and a control mechanism arranged on the vehicle side and carrying the cover element, the control mechanism moving the cover element between an open position exposing the receptacle and a closed position covering the receptacle.

2. The rear cover according to claim 1, wherein the cover element is configured such that the cover element is integrated flush into a rear contour of the motor vehicle in the closed position.

3. The rear cover according to claim 1, wherein the cover element is configured as a plastic component.

4. The rear cover according to claim 1, wherein the control mechanism includes a drive unit, the drive unit driving a movement of the cover element in at least one direction.

5. The rear cover according to claim 4, wherein the drive unit comprises at least one spring motor.

6. The rear cover according to claim 5, wherein the drive unit comprises at least one crank mechanism mechanically coupled to the control mechanism.

7. The rear cover according to claim 1, further comprising a locking device securing the cover element in the closed position.

8. The rear cover according to claim 1, wherein the control mechanism comprises a slot guide assigned to the cover element, the slot guide being configured such that the cover element undergoes a combined swiveling and longitudinal movement between the closed position and the open position.

9. The rear cover according to claim 8, wherein the cover element comprises two support arms and the slot guide comprises two slot guide tracks fixed in relation to the vehicle and two sliding blocks respectively forcibly moving in the two slot guide tracks, the two sliding blocks being respectively fastened to the two support arms of the cover element.

10. The rear cover according to claim 8, wherein the cover element comprises first and second identical pairs of support arms each having sliding blocks fastened thereon, the first and second pairs of support arms being disposed on respective opposite sides of the cover element, the cover element further comprising two carrier parts, the cover element being flanked on each of the two sides by one of the carrier parts, the carrier parts being fixed in relation to the vehicle and having first and second identical slot guide tracks, the sliding blocks being forcibly moved in their respective slot guide tracks, the rear cover further including a synchronizing device configured to create a synchronous movement of the first and second pairs of support arms of the cover element.

11. The rear cover according to claim 10, further including two identical crank mechanisms assigned to the carrier parts and coupled to the support arms of the cover element.

12. The rear cover according to claim 11, wherein the two crank mechanisms respectively comprise two crank rockers, the synchronizing device has a coupling section extending transversely between the carrier parts, the coupling section being rotatably mounted on the carrier parts and having at opposite front end areas the two crank rockers arranged in a co-rotating manner.

13. The rear cover according to claim 12, further including two spring motors oriented coaxially to a rotation axis of the coupling section, wherein the two spring motors are each assigned to one of the two crank rockers and exert a rectified torque on the two crank rockers.

14. (canceled)

15. A motor vehicle comprising:
a receptacle fixed to a rear area of the vehicle for fitting a towing device;
a rear cover, the rear cover comprising:
a cover element movably mounted on a vehicle side; and
a control mechanism arranged on the vehicle side and carrying the cover element, the control mechanism moving the cover element between an open position exposing the receptacle and a closed position covering the receptacle.
